(19) United States
(12) Patent Application Publication
(10) Pub. No.: US 2025/0123018 A1
(43) Pub. Date: Apr. 17, 2025

(54) HEAT EXCHANGE CONTROL DEVICE FOR ELECTRIC VEHICLE AND CONTROL METHOD THEREOF

(71) Applicant: FOXTRON VEHICLE TECHNOLOGIES CO., LTD., New Taipei City (TW)

(72) Inventor: CHIA-HUI TAI, New Taipei City (TW)

(21) Appl. No.: 18/399,654

(22) Filed: Dec. 28, 2023

(30) Foreign Application Priority Data
Oct. 16, 2023 (TW) 112139446

(51) Int. Cl. F24F 11/79; F24F 1/0011; F24F 13/20

(52) U.S. Cl. CPC F24F 11/79; F24F 1/0011; F24F 13/20

(57) ABSTRACT

A heat exchange control device for an electric vehicle and a control method thereof are provided. The heat exchange control device includes an airflow guide cover and an airflow adjusting member. The airflow guide cover includes an air inlet, an air outlet, and an airflow channel between the air inlet and the air outlet. The air inlet is communicatively connected with an air intake at a front portion of a vehicle body. A water tank and a condenser are disposed in the airflow channel and adjacent to the air outlet. The airflow adjusting member is disposed inside the air inlet of the airflow guide cover. The airflow adjusting member is configured to adjust an air intake flow rate and an airflow direction of an airflow passing through the air inlet.

### CROSS-REFERENCE TO RELATED PATENT APPLICATION

This application claims the benefit of priority to Taiwan Patent Application No. 112139446, filed on Oct. 16, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a heat exchange control device, and more particularly to a heat exchange control device for an electric vehicle and a control method thereof.

### BACKGROUND OF THE DISCLOSURE

In response to the increasing global emphasis on energy conservation, carbon reduction, and environmental protection, countries around the world encourage the replacement of fuel vehicles with electric vehicles. Therefore, electric vehicle technology has developed rapidly in recent years and has become a major trend in the world. Comparing with conventional fuel vehicles that use engines and gearboxes as power systems, electric vehicles mainly adopt an EIC system, which includes a motor system (or an electric drive system), an electronic control system, and a battery system. In addition, electric vehicles often have a heat pump system to adjust the temperature of the passenger cabin.

Because temperature changes significantly affect the operation of the EIC system, cooling and heating mechanisms are particularly important for electric vehicles. In order to regulate the operating temperature of the EIC system, the electric vehicles easily consume additional energy, resulting in a reduction in the cruising mileage of the electric vehicles. Therefore, how to effectively improve the heat exchange control effect of the electric vehicles through improvements in structural design so as to overcome the aforementioned shortcomings has become an important issue to be addressed in the relevant field.

### SUMMARY OF THE DISCLOSURE

In response to the above-referenced technical inadequacies, the present disclosure provides a heat exchange control device for an electric vehicle and a control method thereof. The heat exchange control device can effectively adjust the heat dissipation ratio of the water tank to the condenser to respond to temperature requirements of the EIC system and the cabin, thereby improving the performance of the electric vehicle.

In one aspect, the present disclosure provides a heat exchange control device for an electric vehicle. The heat exchange control device includes an airflow guide cover and an airflow adjusting member. The airflow guide cover includes an air inlet, an air outlet, and an airflow channel between the air inlet and the air outlet. The air inlet is communicatively connected with an air intake at a front portion of a vehicle body. A water tank and a condenser are disposed in the airflow channel and adjacent to the air outlet. The airflow adjusting member is disposed inside the air inlet of the airflow guide cover. The airflow adjusting member is configured to adjust an air intake flow rate and an airflow direction of an airflow passing through the air inlet.

In one of the possible or preferred embodiments, the airflow adjusting member includes a plurality of guide vanes that are spaced apart from each other, and the plurality of guide vanes are configured to perform a rotation and swing operation relative to the air inlet, so as to control an opening degree of the air inlet.

In one of the possible or preferred embodiments, the heat exchange control device further includes a motor. The plurality of guide vanes are operatively connected to the motor, and the motor is configured to drive the plurality of guide vanes to perform the rotation and swing operation according to a control command.

In one of the possible or preferred embodiments, a cross-sectional area of the airflow channel is gradually increased from the air inlet to the air outlet, and the air outlet is obliquely arranged relative to the air inlet.

In one of the possible or preferred embodiments, a ratio of a cross-sectional area of the air inlet to a cross-sectional area of the air outlet ranges from 1:2 to 1:3.5.

In one of the possible or preferred embodiments, the airflow guide cover includes an upper guide plate and a lower guide plate, and the upper guide plate and the lower guide plate are combined and matched to form the air inlet, the airflow channel, and the air outlet. The upper guide plate has an airflow guide surface, the lower guide plate has an inner surface opposite to the airflow guide surface, and the airflow guide surface and the inner surface extend from the air inlet to the air outlet in directions away from each other. Moreover, an extension distance of the airflow guide surface is greater than an extension distance of the inner surface.

In one of the possible or preferred embodiments, the condenser is disposed at the air outlet and occupies the air outlet. The water tank is located between the condenser and the air inlet and is located at a position adjacent to the lower guide plate, and the water tank takes up ⅓ to ½ of the air outlet.

In one of the possible or preferred embodiments, an inclination angle is defined between an extension direction of the air inlet and an extension direction of the air outlet, and the inclination angle ranges from 45 degrees to 60 degrees. The water tank and the condenser are obliquely arranged relative to the air inlet according to the inclination angle and are arranged at a position adjacent to the air outlet.

In one of the possible or preferred embodiments, a flow guiding angle is defined between the extension direction of the air inlet and an extension direction of the airflow guide surface, and the flow guiding angle ranges from 60 degrees to 90 degrees. The flow guiding angle is greater than the inclination angle.

In one of the possible or preferred embodiments, the heat exchange control device further includes at least one exhaust portion disposed on a lower fender that is located below the front portion of the vehicle body. The at least one exhaust portion each includes an exhaust outlet facing the airflow guide cover, and a rectifier channel, the rectifier channel is formed by the lower fender being recessed toward inside of the vehicle body, and the rectifier channel is gradually widened toward one end of the airflow guide cover to form the exhaust outlet.

In another aspect, the present disclosure provides a control method for a heat exchange control device for an electric vehicle. The control method includes the following steps. First, at least one environmental parameter of an electric vehicle is detected by at least one detector, and the at least one environmental parameter is communicated and transmitted to a main controller of the electric vehicle. Next, the main controller determines a preset heat exchange mode according to the at least one environmental parameter, and the preset heat exchange mode is suitable for a current state of the electric vehicle. Lastly, the main controller adjusts an airflow adjusting member of a heat exchange control device according to the preset heat exchange mode, so as to assist in regulating the cooling of a water tank and a condenser of the electric vehicle. The heat exchange control device includes an airflow guide cover and the airflow adjusting member. The airflow guide cover has an air inlet, an air outlet, and an airflow channel between the air inlet and the air outlet. The air inlet is communicatively connected with an air intake at a front portion of a vehicle body. The water tank and the condenser are disposed in the airflow channel and adjacent to the air outlet. The airflow adjusting member is disposed inside the air inlet of the airflow guide cover. The airflow adjusting member is configured to adjust an air intake flow rate and an airflow direction of an airflow passing through the air inlet.

In one of the possible or preferred embodiments, the airflow adjusting member includes a plurality of guide vanes that are spaced apart from each other, and the plurality of guide vanes are configured to perform a rotation and swing operation relative to the air inlet, so as to control an opening degree of the air inlet. In the step of adjusting the airflow adjusting member of the heat exchange control device by the main controller according to the preset heat exchange mode, the main controller sends a control command to a motor that is operatively connected to the plurality of guide vanes, and the motor drives the plurality of guide vanes to perform the rotation and swing operation according to the control command.

In one of the possible or preferred embodiments, when the preset heat exchange mode is a first operating mode and the plurality of guide vanes are in a first operating position of the rotation and swing operation, the opening degree of the air inlet is 100%. When the preset heat exchange mode is a second operating mode and the plurality of guide vanes are in a second operating position of the rotation and swing operation, the opening degree of the air inlet is 0%. When the preset heat exchange mode is a third operating mode and the plurality of guide vanes are in a third operating position of the rotation and swing operation, the opening degree of the air inlet is between 0% and 30%. When the preset heat exchange mode is a fourth operating mode and the plurality of guide vanes are in a fourth operating position of the rotation and swing operation, the opening degree of the air inlet is between 30% and 60%. When the preset heat exchange mode is a fifth operating mode and the plurality of guide vanes are in a fifth operating position of the rotation and swing operation, the opening degree of the air inlet is between 60% and 90%.

Therefore, in the heat exchange control device for the electric vehicle and the control method thereof provided by the present disclosure, by virtue of the water tank and the condenser being disposed in the airflow channel and adjacent to the air outlet, the airflow adjusting member being disposed inside the air inlet of the airflow guide cover and being configured to adjust the air intake flow rate and the airflow direction of the airflow passing through the air inlet, the heat dissipation ratio of the water tank to the condenser can be effectively regulated. Therefore, according to the driving conditions of the electric vehicle under different temperature environments, the cooling and heating requirements of the heat pump system for the EIC system and the cabin air conditioner can be met.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective cross-sectional view of a heat exchange control device for an electric vehicle according to a first embodiment of the present disclosure;

FIG. 2 is a schematic side view of FIG. 1;

FIG. 3 is a schematic partially enlarged view of FIG. 2;

FIG. 4 is a schematic cross-sectional view of the electric vehicle in a driving state with an opening degree of an air inlet being 100% according to the first embodiment of the present disclosure;

FIG. 5 is a schematic cross-sectional view of the electric vehicle in a driving state with the opening degree of the air inlet being 20% according to the first embodiment of the present disclosure;

FIG. 6 is a schematic cross-sectional view of the electric vehicle in a driving state with the opening degree of the air inlet being 0% according to the first embodiment of the present disclosure;

FIG. 7 is a functional block diagram of a control system of a heat exchange control device for an electric vehicle according to a second embodiment of the present disclosure; and

FIG. 8 is a flowchart of a control method of the heat exchange control device for the electric vehicle according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

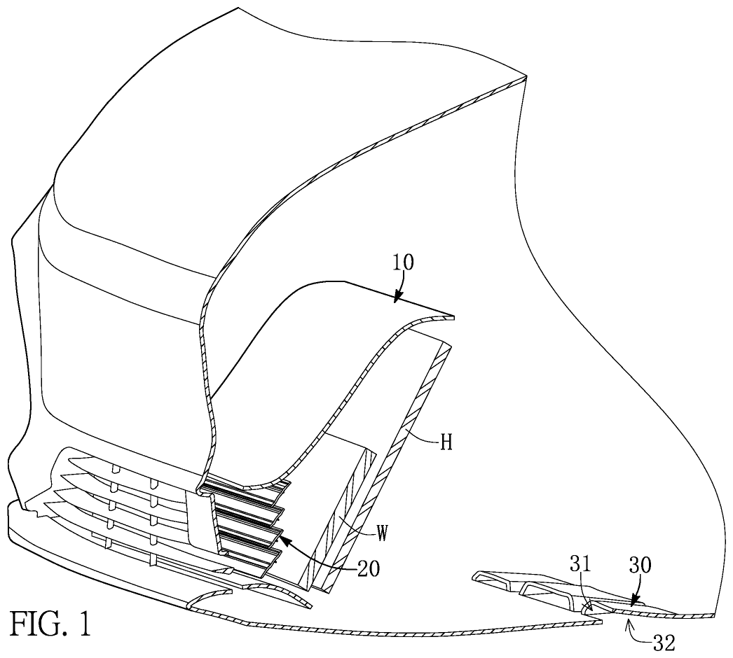

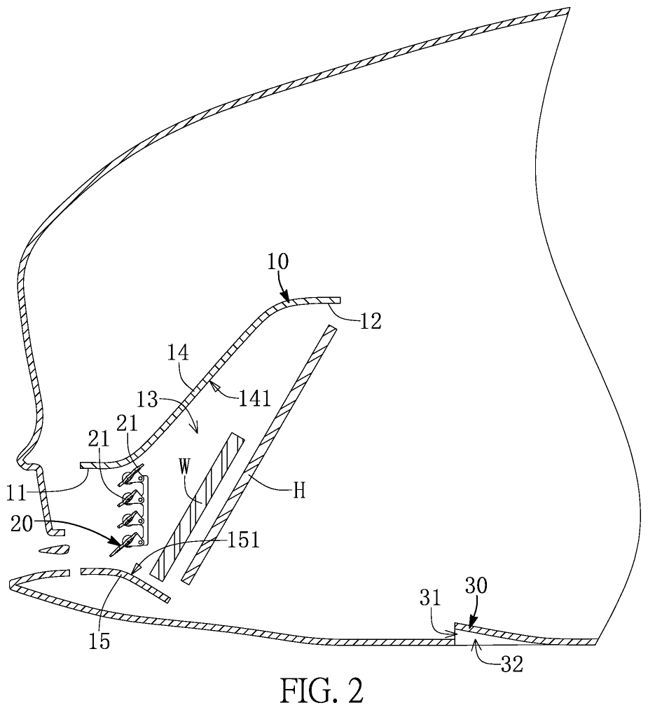

Referring to FIG. 1 and FIG. 2, a first embodiment of the present disclosure provides a heat exchange control device for an electric vehicle. The heat exchange control device mainly includes an airflow guide cover 10 and an airflow adjusting member 20.

The airflow guide cover 10 includes an air inlet 11, an air outlet 12, and an airflow channel 13 between the air inlet 11 and the air outlet 12. Specifically, the heat exchange control device for the electric vehicle of the present disclosure is mainly disposed at a front portion of a vehicle body, and the air inlet 11 of the airflow guide cover 10 is communicatively connected with an air intake at the front portion of the vehicle body. Generally, the air intake at the front portion of the vehicle body may be located at an air intake grille or a front bumper of the vehicle, but the present disclosure is not limited thereto.

A water tank W and a condenser H are disposed in the airflow channel 13 at a position adjacent to the air outlet 12. When the electric vehicle is in a driving state, an external airflow will enter the air intake at the front portion of the vehicle body, sequentially pass through the air inlet 11, the airflow channel 13, and the air outlet 12 of the airflow guide cover 10, and perform heat exchange with the water tank W and the condenser H. Furthermore, the water tank W and the condenser H are components of an EIC system of the electric vehicle. Specifically, the water tank W can be a water tank W for cooling a motor, and the condenser H can be a condenser H for heat dissipation in a battery and an air conditioner. Through the structural design of the airflow guide cover 10 and the configuration of the airflow adjusting member 20 of the present disclosure, a heat dissipation ratio of the water tank W and the condenser H can be effectively regulated. The structure and configuration of the airflow guide cover 10 and the airflow adjusting member 20 are described in detail below.

Referring to FIG. 1 and FIG. 2, the airflow guide cover 10 further includes an upper guide plate 14 and a lower guide plate 15, and the upper guide plate 14 and the lower guide plate 15 are combined and matched to form the air inlet 11, the airflow channel 13, and the air outlet 12. Specifically, the upper guide plate 14 has an airflow guide surface 141, the lower guide plate 15 has an inner surface 151 opposite to the airflow guide surface 141, and the airflow guide surface 141 and the inner surface 151 extend from the air inlet 11 to the air outlet 12 in directions away from each other. It is worth noting that, an extension distance of the airflow guide surface 141 of the upper guide plate 14 is greater than an extension distance of the inner surface 151 of lower guide plate 15. That is, a cross-sectional area of the airflow channel 13 of airflow guide cover 10 is gradually increased from the air inlet 11 to the air outlet 12, and the air outlet 12 is obliquely arranged relative to the air inlet 11.

In this embodiment, based on the ground plane where the electric vehicle is located, the air inlet 11 of the airflow guide cover 10 is disposed perpendicular to the ground plane at the front portion of the vehicle body. Therefore, the air outlet 12 of the airflow guide cover 10 is obliquely arranged in the vehicle body, such that the air outlet 12 has a relatively large heat dissipation area. For instance, a ratio of the cross-sectional area of the air inlet 11 to the cross-sectional area of the air outlet 12 can range from 1:2 to 1:3.5, and preferably is 1:2.5. The structural design of the airflow guide cover 10 of the present disclosure can enable the airflow to produce a Venturi effect to enhance the heat exchange effect. However, the aforementioned details are disclosed for exemplary purposes only, and are not meant to limit the scope of the present disclosure.

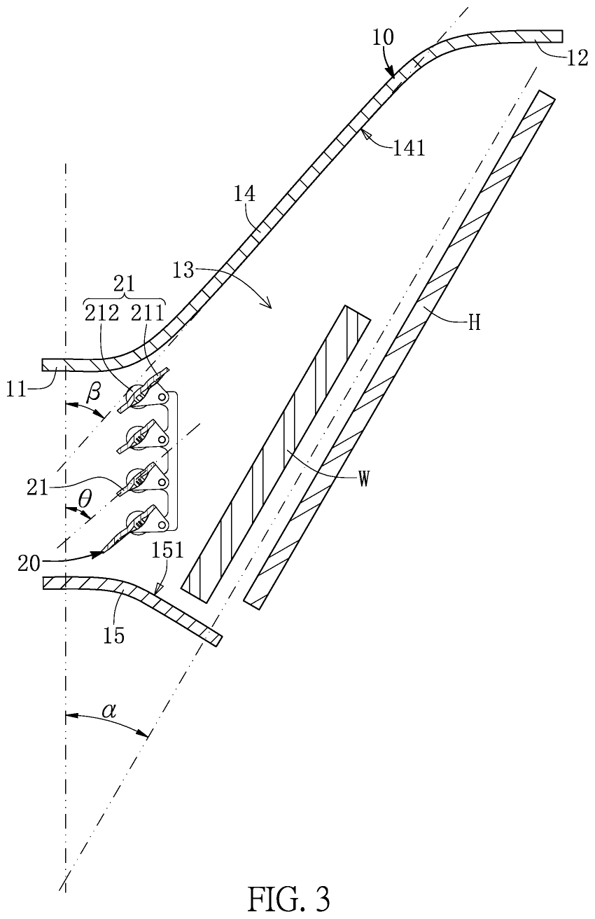

Referring to FIG. 3, an inclination angle α is defined between an extension direction of the air inlet and an extension direction of the air outlet 12, and the inclination angle α can range from 45 degrees to 60 degrees. It is worth noting that the water tank W and the condenser H also are obliquely arranged relative to the air inlet 11 according to the inclination angle α and arranged at a position adjacent to the air outlet 12. Therefore, the water tank W and the condenser H also have relatively large heat dissipation areas.

In order to allow the airflow entering the air inlet 11 to effectively dissipate heat to the water tank W and the condenser H, a flow guiding angle β is defined between the extension direction of the air inlet 11 and an extension direction of the airflow guide surface 14, and the flow guiding angle β is greater than the inclination angle α. Therefore, the airflow can dissipate heat to the water tank W and the condenser H along positions from the airflow guide surface 141 to the air outlet 12. In this embodiment, the flow guiding angle β can range from 60 degrees to 90 degrees, but is not limited thereto.

Referring to FIG. 1 to FIG. 6, the airflow adjusting member 20 is disposed inside the air inlet 11 of the airflow guide cover 10. The airflow adjusting member 20 is configured to adjust an air intake flow rate and an airflow direction of an airflow passing through the air inlet 11.

Referring to FIG. 3, the airflow adjusting member 20 can include a plurality of guide vanes 21 that are spaced apart from each other. The plurality of guide vanes 21 are configured to perform a rotation and swing operation relative to the air inlet 11, so as to control an opening degree of the air inlet 11. For instance, the plurality of guide vanes 21 are arranged to be spaced apart from each other in a top-down manner inside the air inlet 11. Each of the plurality of guide vanes 21 can be a rectangular sheet and has an air guide surface 211. Each of the plurality of guide vanes 21 has a rotating shaft 212, and both ends of the rotating shaft 212 are rotatably fixed to opposite sides of the air inlet 11, respectively. The rotating shaft 212 rotates to swing each of the plurality of guide vanes 21 and control a rotation angle θ of the plurality of guide vanes 21. However, the aforementioned details are disclosed for exemplary purposes only, and are not meant to limit the scope of the present disclosure.

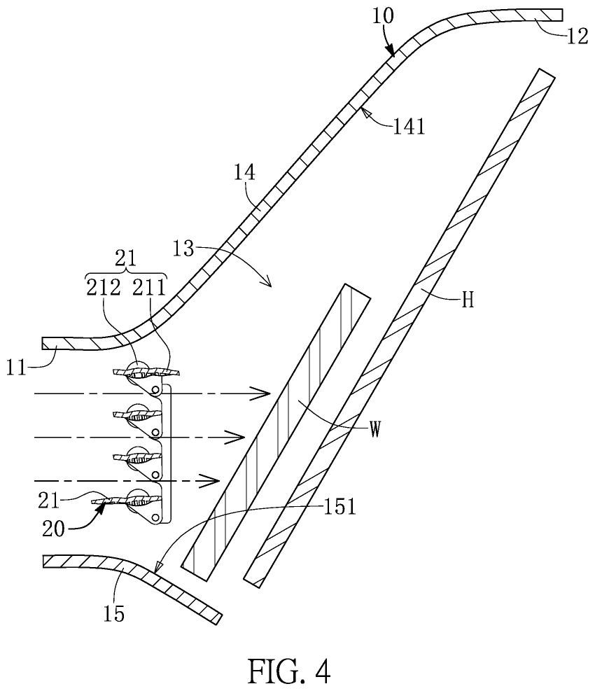

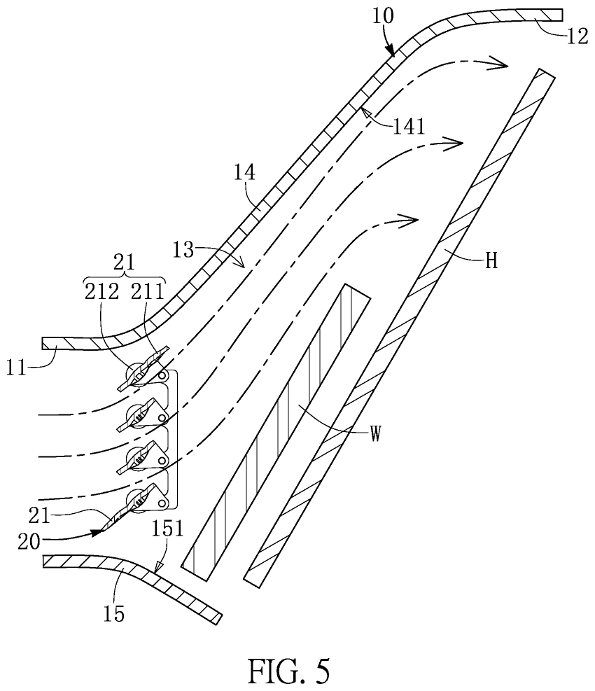

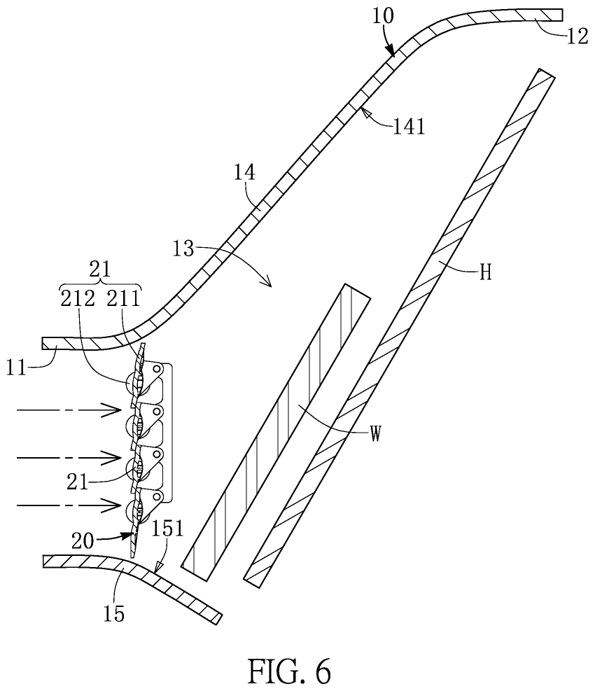

Referring to FIG. 4 to FIG. 6, which are to be read in conjunction with FIG. 3, the rotation angle θ of each of the plurality of guide vanes 21 can range from 90 degrees to 0 degrees (that is, the air guide surface 211 is gradually moved along the rotating shaft 212 to face the air inlet 11), so as to adjust the opening degree of the air inlet 11. Referring to FIG. 4, which is to be read in conjunction with FIG. 3, when the rotation angle θ of each of the plurality of guide vanes 21 is approximately 90 degrees, the air guide surface 211 of each of the plurality of guide vanes 21 is parallel to an opening direction of the air inlet 11 of the airflow guide cover 10, and the opening degree of the air inlet 11 is 100%. Referring to FIG. 6, which is to be read in conjunction with FIG. 3, when the rotation angle θ of each of the plurality of guide vanes 21 is approximately 0 degrees, the air guide surface 211 of each of the plurality of guide vanes 21 is perpendicular to the opening direction of the air inlet 11 of the airflow guide cover 10, and the opening degree of the air inlet 11 is 0%. When the rotation angle θ of each of the plurality of guide vanes 21 is approximately 9 degrees, the opening degree of the air inlet 11 is 10%. When the rotation angle θ of each of the plurality of guide vanes 21 is approximately 18 degrees, the opening degree of the air inlet 11 is 20% (as shown in FIG. 5, which is to be read in conjunction with FIG. 3). When the rotation angle θ of each of the plurality of guide vanes 21 is approximately 45 degrees, the opening degree of the air inlet 11 is 50%. When the rotation angle θ of each of the plurality of guide vanes 21 is approximately 63 degrees, the opening degree of the air inlet 11 is 70%. It is worth noting that, the larger the rotation angle θ of each of the plurality of guide vanes 21 is, the larger the air intake flow rate is, and the smaller the rotation angle θ of each of the plurality of guide vanes 21 is, the steeper the airflow direction becomes.

Referring to FIG. 1 to FIG. 2, in this embodiment, the heat exchange control device further includes at least one exhaust portion 30 disposed on a lower fender. The lower fender is located at a bottom portion of the vehicle body, specifically, under the front portion of the vehicle body. The at least one exhaust portion 30 each includes an exhaust outlet 31 facing the airflow guide cover 10 and a rectifier channel 32. The rectifier channel 32 is formed by the lower fender being recessed toward the inside of the vehicle body, and the rectifier channel 32 is gradually widened toward one end of the airflow guide cover 10 to form the exhaust outlet 31. In this embodiment, the rectifier channel 32 can be an NACA duct. Therefore, after passing through the air outlet 12, the airflow can leave the interior of the vehicle body through the at least one exhaust portion 30. Generally, a fan is disposed outside the air outlet 12 to assist the airflow to pass through the airflow channel 13. The arrangement of the at least one exhaust portion 30 can allow the airflow to smoothly pass through the airflow channel 13 even when the fan is not operating.

Generally, the heat dissipation requirement of the condenser H is higher than that of the water tank W, and the water tank W will be cooled or insulated according to the requirements inside the electric vehicle. In this embodiment, the condenser H is disposed at the air outlet 12 and occupies the air outlet 12, the water tank W is located between the condenser H and the air inlet 11 and adjacent to the lower guide plate 15, and the water tank W takes up ⅓ to ½ of the air outlet 12. That is to say, a heat dissipation area of the water tank W is ⅓ to ½ of an area of a heat dissipation area of the condenser H. In other embodiments, the heat dissipation area of the water tank W can be calculated based on the loss calculation of the motor system, and the heat dissipation area of the condenser H can be designed based on the heat dissipation requirements of the battery and the air conditioner. Moreover, the water tank W and the condenser H can be arranged according to the correlation between the shape of openings and the vehicle body structure, so as to achieve the optimized air intake efficiency. However, the aforementioned details are disclosed for exemplary purposes only, and are not meant to limit the scope of the present disclosure.

In this embodiment, the heat exchange control device for the electric vehicle of the present disclosure can further include a motor, and the plurality of guide vanes 21 are operatively connected to the motor. In other words, the rotating shaft 212 of each of the plurality of guide vanes 21 can be operatively connected with the motor. For instance, the motor can be configured to drive the plurality of guide vanes 21 to perform a rotation and swing operation according to a control command, and the control command can be issued through a main controller of the electric vehicle.

Therefore, referring to FIG. 1 to FIG. 6, by the structural design of the airflow guide cover 10, the plurality of guide vanes 21 having an adjustable rotation angle θ, and the arrangement positions of the water tank W and the condenser H, the heat dissipation ratio of the water tank W and the condenser H can be effectively distributed, so as to improve the operating efficiency of the electric vehicle.

### Second Embodiment

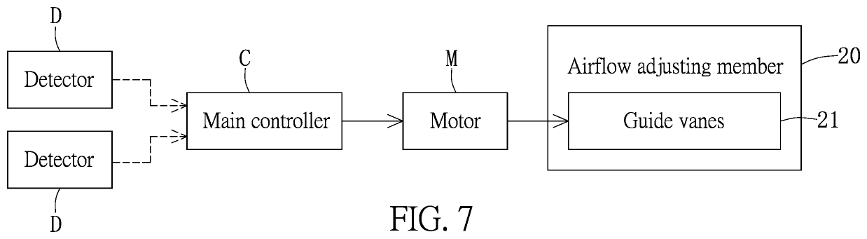

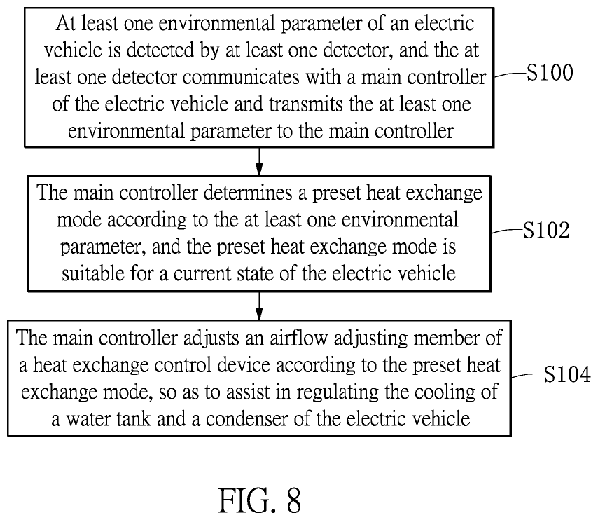

Referring to FIG. 7 and FIG. 8, which are to be read in conjunction with FIG. 1, a second embodiment of the present disclosure provides a control method for a heat exchange control device for an electric vehicle, and the control method can at least include following steps S100 to S104. In step S100, at least one environmental parameter of an electric vehicle is detected by at least one detector D, and the at least one detector D communicates with a main controller C of the electric vehicle and transmits the at least one environmental parameter to the main controller C. In step S102, the main controller C determines a preset heat exchange mode according to the at least one environmental parameter, and the preset heat exchange mode is suitable for a current state of the electric vehicle. In step S104, the main controller C adjusts an airflow adjusting member 20 of a heat exchange control device according to the preset heat exchange mode, so as to assist in regulating the cooling of a water tank W and a condenser H of the electric vehicle. In addition, the heat exchange control device for the electric vehicle can be the heat exchange control device as described in the first embodiment, and the detailed structure of the heat exchange control device will not be reiterated herein.

The control system configuration of the heat exchange control device can be substantially referred to in FIG. 7. The main controller C is communicatively connected with the at least one detector D and the motor M, and the motor M is operatively connected with the airflow adjusting member 20 of the heat exchange control device of the electric vehicle. Specifically, referring to FIG. 7, which is to be read in conjunction with FIG. 3, the motor M can adjust the rotation angle θ of the plurality of guide vanes 21 by driving each rotating shaft 212 (such as the airflow adjusting member 20 described in the first embodiment) of the plurality of guide vanes 21 to rotate.

Referring to FIG. 8, which is to be read in conjunction with FIG. 3, specifically, in step S100, at least one environmental parameter may include electric vehicle external temperature, vehicle motor temperature, electronic control temperature, battery pack temperature, air conditioning pipeline pressure, vehicle speed, passenger cabin air conditioning settings, and so on, but is not limited thereto. In step S102, the main controller C receives the at least one environmental parameter to evaluate the cooling and heating requirements of the electric vehicle and then determines the preset heat exchange mode. In step S104, the main controller C sends a control command to the motor M according to the preset heat exchange mode, and the motor M drives the plurality of guide vanes 21 to perform a rotation and swing operation according to the control command.

Referring to FIG. 7, which is to be read in conjunction with FIG. 3 and FIG. 4, for instance, when the detector D senses that the electric vehicle travels at a high speed in an external high-temperature environment, and the passenger cabin cooling air conditioner is turned on, the plurality of detectors D transmit the plurality of environmental parameters to the main controller C. The main controller C analyzes that the water tank W and the condenser H need to be cooled rapidly and significantly, and the main controller C determines that the preset heat exchange mode is a first operating mode. The main controller C sends the control command to the motor M, and the motor M drives the plurality of guide vanes 21 to perform the rotation and swing operation, such that the plurality of guide vanes 21 are in a first operating position. Therefore, the air guide surface 211 of each of the plurality of guide vanes 21 is parallel to an opening direction of the air inlet 11 of the airflow guide cover 10 (that is, the rotation angle θ of each of the plurality of guide vanes 21 is approximately 90 degrees), and the opening degree of the air inlet 11 is 100%, such that heat exchange is directly and quickly performed between the water tank W and the condenser H.

Referring to FIG. 7, which is to be read in conjunction with FIG. 3 and FIG. 6, when the detector D senses that the electric vehicle travels in an external low-temperature environment, and the passenger cabin heating air conditioning is turned on, the plurality of detectors D transmit the plurality of environmental parameters to the main controller C. The main controller C analyzes that the water tank W and the condenser H need to be insulated to increase the temperature rise rate of the control system, and the main controller C determines that the preset heat exchange mode is a second operating mode. The main controller C sends the control command to the motor M, and the motor M drives the plurality of guide vanes 21 to perform the rotation and swing operation, such that the plurality of guide vanes 21 are in a second operating position. Therefore, the air guide surface 211 of each of the plurality of guide vanes 21 is perpendicular to the opening direction of the air inlet 11 of the airflow guide cover 10 and the plurality of guide vanes 21 close the air inlet 11 (that is, the rotation angle θ of each of the plurality of guide vanes 21 is approximately 0 degrees). Therefore, the opening degree of the air inlet 11 is 0%, thereby avoiding the heat exchange to be performed between the water tank W and the condenser H by the airflow.

Referring to FIG. 7, which is to be read in conjunction with FIG. 3 and FIG. 5, for instance, when the plurality of detectors D transmit the plurality of environmental parameters to the main controller C and the main controller C analyzes that a cooling for the water tank W needs to be avoided and the condenser H needs to be slightly cooled, the main controller C determines that the preset heat exchange mode is a third operating mode. The main controller C sends the control command to the motor M, and the motor M drives the plurality of guide vanes 21 to perform the rotation and swing operation, such that the plurality of guide vanes 21 are in a third operating position. Therefore, the rotation angle θ of each of the guide vanes 21 ranges from approximately 0 degrees to 27 degrees, and the opening degree of the air inlet 11 ranges from 0% to 30%. That is, the airflow will avoid flowing in a direction toward the water tank W and will perform heat exchange on the condenser H along the airflow guide surface 141 of the upper guide plate 14.

Referring to FIG. 7, which is to be read in conjunction with FIG. 3, for instance, when the plurality of detectors D transmit the plurality of environmental parameters to the main controller C and the main controller C analyzes that the water tank W and the condenser H need to be slightly cooled, the main controller C determines that the preset heat exchange mode is a fourth operating mode. The main controller C sends the control command to the motor M, and the motor M drives the plurality of guide vanes 21 to perform the rotation and swing operation, such that the plurality of guide vanes 21 are in a fourth operating position. Therefore, the rotation angle θ of each of the plurality of guide vanes 21 ranges from approximately 27 degrees to 54 degrees, and the opening degree of the air inlet 11 ranges from 30% to 60%. That is, the airflow will be slightly directed toward the water tank W and along the airflow guide surface 141 of the upper guide plate 14 to perform heat exchange on the water tank W and the condenser H.

Referring to FIG. 7, which is to be read in conjunction with FIG. 3, for instance, when the plurality of detectors D transmit the plurality of environmental parameters to the main controller C, and the main controller C analyzes that the water tank W and the condenser H need to be significantly cooled, and the main controller C determines that the preset heat exchange mode is a fifth operating mode. The main controller C sends the control command to the motor M, and the motor M drives the plurality of guide vanes 21 to perform the rotation and swing operation, such that the plurality of guide vanes 21 are in a fifth operating position. Therefore, the rotation angle θ of each of the guide vanes 21 ranges from approximately 54 degrees to 81 degrees, and the opening degree of the air inlet 11 ranges from 60% to 90%. That is, the airflow will be partially directed toward the water tank W and along the airflow guide surface 141 of the upper guide plate 14 to perform heat exchange on the water tank W and the condenser H.

However, the aforementioned details are disclosed for exemplary purposes only, and are not meant to limit the scope of the present disclosure.

### BENEFICIAL EFFECTS OF THE EMBODIMENTS

In conclusion, in the heat exchange control device for the electric vehicle and the control method thereof provided by the present disclosure, by virtue of the water tank and the condenser being disposed in the airflow channel and adjacent to the air outlet, the airflow adjusting member being disposed inside the air inlet of the airflow guide cover and being configured to adjust the air intake flow rate and the airflow direction of the airflow passing through the air inlet, the heat dissipation ratio of the water tank to the condenser can be effectively regulated. Therefore, according to the driving conditions of the electric vehicle under different temperature environments, the cooling and heating requirements of the heat pump system for the EIC system and the cabin air conditioner can be met.

Furthermore, in the present disclosure, by obliquely arranging the air outlet, the water tank, and the condenser of the airflow guide cover relative to the air inlet, the heat dissipation areas of the water tank and the condenser can be increased, and the heat dissipation ratio of the water tank and the condenser can be effectively adjusted.

Moreover, by adjusting the opening degree of the air inlet and the direction of the airflow through the rotation angles of the plurality of guide vanes, the increase in energy consumption of the electric vehicle due to excessive cooling of the water tank and/or the condenser can be avoided.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A heat exchange control device for an electric vehicle, comprising:
an airflow guide cover having an air inlet, an air outlet, and an airflow channel between the air inlet and the air outlet, wherein the air inlet is communicatively connected with an air intake at a front portion of a vehicle body, and a water tank and a condenser are disposed in the airflow channel and adjacent to the air outlet; and
an airflow adjusting member disposed inside the air inlet of the airflow guide cover, and the airflow adjusting member is configured to adjust an air intake flow rate and an airflow direction of an airflow passing through the air inlet.

2. The heat exchange control device according to claim 1, wherein the airflow adjusting member includes a plurality of guide vanes that are spaced apart from each other, and the plurality of guide vanes are configured to perform a rotation and swing operation relative to the air inlet, so as to control an opening degree of the air inlet.

3. The heat exchange control device according to claim 2, further comprising a motor, wherein the plurality of guide vanes are operatively connected to the motor, and the motor is configured to drive the plurality of guide vanes to perform the rotation and swing operation according to a control command.

4. The heat exchange control device according to claim 1, wherein a cross-sectional area of the airflow channel is gradually increased from the air inlet to the air outlet, and the air outlet is obliquely arranged relative to the air inlet.

5. The heat exchange control device according to claim 4, wherein a ratio of a cross-sectional area of the air inlet to a cross-sectional area of the air outlet ranges from 1:2 to 1:3.5.

6. The heat exchange control device according to claim 4, wherein the airflow guide cover includes an upper guide plate and a lower guide plate, and the upper guide plate and the lower guide plate are combined and matched to form the air inlet, the airflow channel, and the air outlet; wherein the upper guide plate has an airflow guide surface, the lower guide plate has an inner surface opposite to the airflow guide surface, and the airflow guide surface and the inner surface extend from the air inlet to the air outlet in directions away from each other; wherein an extension distance of the airflow guide surface is greater than an extension distance of the inner surface.

7. The heat exchange control device according to claim 6, wherein the condenser is disposed at the air outlet and occupies the air outlet; wherein the water tank is located between the condenser and the air inlet and is located at a position adjacent to the lower guide plate, and the water tank takes up ⅓ to ½ of the air outlet.

8. The heat exchange control device according to claim 6, wherein an inclination angle is defined between an extension direction of the air inlet and an extension direction of the air outlet, and the inclination angle ranges from 45 degrees to 60 degrees; wherein the water tank and the condenser are obliquely arranged relative to the air inlet according to the inclination angle and are arranged at a position adjacent to the air outlet.

9. The heat exchange control device according to claim 8, wherein a flow guiding angle is defined between the extension direction of the air inlet and an extension direction of the airflow guide surface, and the flow guiding angle ranges from 60 degrees to 90 degrees; wherein the flow guiding angle is greater than the inclination angle.

10. The heat exchange control device according to claim 8, further comprising: at least one exhaust portion disposed on a lower fender that is located below the front portion of the vehicle body; wherein the at least one exhaust portion each includes an exhaust outlet facing the airflow guide cover, and a rectifier channel, the rectifier channel is formed by the lower fender being recessed toward inside of the vehicle body, and the rectifier channel is gradually widened toward one end of the airflow guide cover to form the exhaust outlet.

11. A control method for a heat exchange control device for an electric vehicle, comprising:
detecting at least one environmental parameter of an electric vehicle by at least one detector, and communicatively transmitting the at least one environmental parameter to a main controller of the electric vehicle;
determining a preset heat exchange mode according to the at least one environmental parameter by the main controller, wherein the preset heat exchange mode is suitable for a current state of the electric vehicle; and
adjusting an airflow adjusting member of a heat exchange control device by the main controller according to the preset heat exchange mode, so as to assist in regulating the cooling of a water tank and a condenser of the electric vehicle;
wherein the heat exchange control device includes:
an airflow guide cover having an air inlet, an air outlet, and an airflow channel between the air inlet and the air outlet, wherein the air inlet is communicatively connected with an air intake at a front portion of a vehicle body, and the water tank and the condenser are disposed in the airflow channel and adjacent to the air outlet; and
the airflow adjusting member disposed inside the air inlet of the airflow guide cover, and the airflow adjusting member is configured to adjust an air intake flow rate and an airflow direction of an airflow passing through the air inlet.

12. The control method according to claim 11, wherein the airflow adjusting member includes a plurality of guide vanes that are spaced apart from each other, and the plurality of guide vanes are configured to perform a rotation and swing operation relative to the air inlet, so as to control an opening degree of the air inlet; wherein, in the step of adjusting the airflow adjusting member of the heat exchange control device by the main controller according to the preset heat exchange mode, the main controller sends a control command to a motor that is operatively connected to the plurality of guide vanes, and the motor drives the plurality of guide vanes to perform the rotation and swing operation according to the control command.

13. The control method according to claim 12, wherein, when the preset heat exchange mode is a first operating mode and the plurality of guide vanes are in a first operating position of the rotation and swing operation, the opening degree of the air inlet is 100%; wherein, when the preset heat exchange mode is a second operating mode and the plurality of guide vanes are in a second operating position of the rotation and swing operation, the opening degree of the air inlet is 0%; wherein, when the preset heat exchange mode is a third operating mode and the plurality of guide vanes are in a third operating position of the rotation and swing operation, the opening degree of the air inlet is between 0% and 30%; wherein, when the preset heat exchange mode is a fourth operating mode and the plurality of guide vanes are in a fourth operating position of the rotation and swing operation, the opening degree of the air inlet is between 30% and 60%; wherein, when the preset heat exchange mode is a fifth operating mode and the plurality of guide vanes are in a fifth operating position of the rotation and swing operation, the opening degree of the air inlet is between 60% and 90%.
